(19) United States
(12) Patent Application Publication
(10) Pub. No.: US 2005/0184221 A1
(43) Pub. Date: Aug. 25, 2005

(54) Optical power meter

(75) Inventors: Pie-Yau Chien, Taichung Hsien (TW); Xiao-Yong Wang, Hang-zhou (CN)

Correspondence Address: RADER FISHMAN & GRAUER PLLC, LION BUILDING, 1233 20TH STREET N.W., SUITE 501, WASHINGTON, DC, 20036, US

(73) Assignee: Asia Optical Co., Inc.

(21) Appl. No.: 11/033,265

(22) Filed: Jan. 12, 2005

(30) Foreign Application Priority Data
Feb. 20, 2004 (TW) 093104349

(51) Int. Cl. H01J 40/14

(52) U.S. Cl. 250/214 R

(57) ABSTRACT

An optical power meter including a photodiode and an amplifier circuit is provided. The photodiode is for generating a current based on the power of a light beam incidents thereon. The amplifier circuit is for converting the current into a voltage and includes an amplifier, a capacitor, a plurality of resistors and a relay. The amplifier includes an inverting input terminal and an output terminal. The capacitor has a first terminal connected with the inverting input terminal and a second terminal connected with the output terminal. Each of the plurality of resistors has a first terminal connected with the inverting input terminal. The relay has a first terminal connected with the output terminal. The relay selectively connects one of the resistors with the output terminal so that the value of the voltage outputted by the output terminal is within a predetermined range. The on-resistance of the relay is not larger than 10 Ω.

### CROSS REFERENCE TO RELATED APPLICATIONS

This application claims priority of Taiwan Patent Application Serial No. 093104349 entitled “OPTICAL POWER METER”, filed on Feb. 20, 2004.

### FIELD OF THE INVENTION

The present invention relates to an optical power meter, and more particularly, to an optical power meter with adjustable measurement range.

### BACKGROUND OF THE INVENTION

The conventional method for measuring optical power is described as follow. A photodiode is irradiated by an incident light beam to generate a current according to the power of the incident light beam. The current is converted into a voltage. The voltage is then converted to a digital signal by an analog-to-digital converter (A/D converter). Finally, the digital signal is converted by a controller to a value of optical power. In typical, the range of the optical power usually spreads across seven orders of magnitude. Thus, the range of the generated current corresponding to the optical power is usually wide. However, the desired operation range in the A/D converter is usually about two orders of magnitude, in which linear conversion is achieved. Therefore, the measuring range should be adjustable during the conversion from current to voltage to assure the optical power of different orders of magnitude could be measured accurately.

Conventional optical power meter utilizes an analog switch to adjust the measurement range. However, on-resistance of the analog switch is relatively high, i.e. tens to hundreds of ohms (Ω), thus linearity of the conversion from optical signal to electric signal is seriously affected and the following conversion becomes difficult. Therefore, it is required to provide an optical power meter with adjustable measurement range and desired linear conversion from optical signal to electric signal.

### SUMMARY OF THE INVENTION

It is one aspect of the present invention to provide an optical power meter with adjustable measurement range and desired linear conversion from optical signal to electric signal.

The present invention provides an optical power meter including a photodiode and an amplifier circuit. The photodiode is provided for generating a current based on power of an incident light beam. The amplifier circuit is provided for converting the current into a voltage. The amplifier circuit includes an amplifier, a capacitor, a plurality of resistors, and a relay. The amplifier has an inverting input terminal and an output terminal. The capacitor has a first terminal connected with the inverting input terminal and a second terminal connected with the output terminal. The capacitor is provided to stabilize the signal and not the essential element to the present invention. Each of the resistors has a first terminal connected with the inverting input terminal. The relay has a first terminal connected with the output terminal. Wherein the relay selectively connects one of the plurality of resistors with the output terminal so that the value of the voltage outputted by the output terminal is within a predetermined range, and the on-resistance of the relay is not larger than 10 Ω. Since the resistance of the relay is very small, the linearity of the conversion from optical signal to electric signal is nearly unaffected. Therefore, the present invention provides an optical power meter with adjustable measurement range and linear conversion from optical signal to electric signal.

The measured resolution of optical power depends on the quantities of relays utilized in the above-mentioned optical power meter. Multiple relays provide a plurality of modes for adjusting measurement range, thus more accurate results could be obtained.

The optical power meter may include a controller in accordance with the present invention. The controller includes an analog-to-digital converter for converting a voltage to a digital signal. The controller determines whether the voltage is within a predetermined range and decides whether the measurement range of optical power should be switched to another mode by receiving the digital signal from controller. For example, when the range of optical power meter is between +3 dBm to −70 dBm, the predetermined range is between 15 mV to 1.1 V. Note that the predetermined range is changeable when the range of optical power is changed. The controller selectively connects one of the resistors with the output terminal. The controller processes the digital signal to generate a result. The controller may process the digital signal either according to a wavelength of the incident light beam, or according to a display format of the result.

The optical power meter may further include a monitor for displaying the result in accordance with the present invention. The optical power meter may further include an input device for a user to communicate with the controller in accordance with the present invention.

### BRIEF DESCRIPTION OF THE DRAWINGS

FIG. 1 is a block diagram of one embodiment in accordance with the present invention;

FIG. 2 is a circuitry of amplifier circuit in FIG. 1; and

FIG. 3 is a schematic diagram illustrating each mode of measuring range of current corresponding to each resistor.

### DETAILED DESCRIPTION OF THE INVENTION

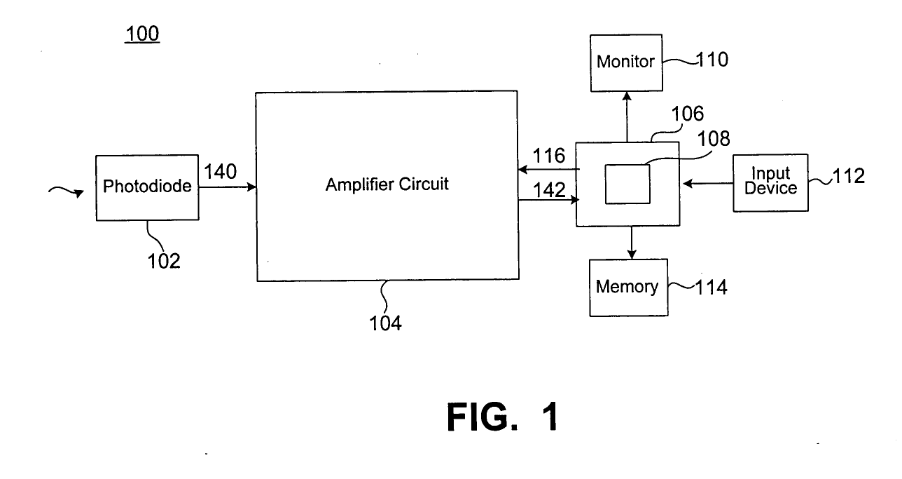

FIG. 1 is a block diagram of an embodiment 100 in accordance with the present invention. When the incident light beam irradiates the photodiode 102, the photodiode 102 generates a current 140 based on power of the incident light beam. The amplifier circuit 104 converts the current 140 to a voltage 142. The analog-to-digital converter (A/D converter) 108 of the controller 106 converts the voltage 142 to a digital signal. The controller 106 processes the digital signal to generate a result 117 and displays the corresponding power on a monitor 110. The type of photodiode 102 may depend on the wavelength of the incident light beam. In the embodiment 100, for example, an InGaAs positive-intrinsic-negative photodiode is provided as the photodiode 102.

Various A/D converters could be implemented in the present invention, e.g. 8 bits, 12 bits, 24 bits, etc. A 24 bits A/D converter is implemented for the converter 108. Various modes of measurement range may be provided during conversion of the current 140 to the voltage 142 in order to accurately measure the optical power of different magnitudes. The actual number of modes may depend on the required accuracy, property of the A/D converter, etc. Four modes are provided in the embodiment 100.

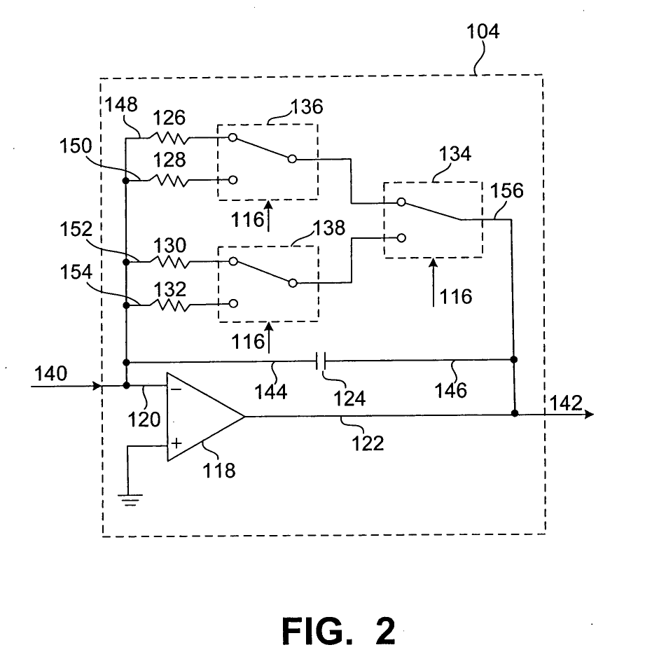

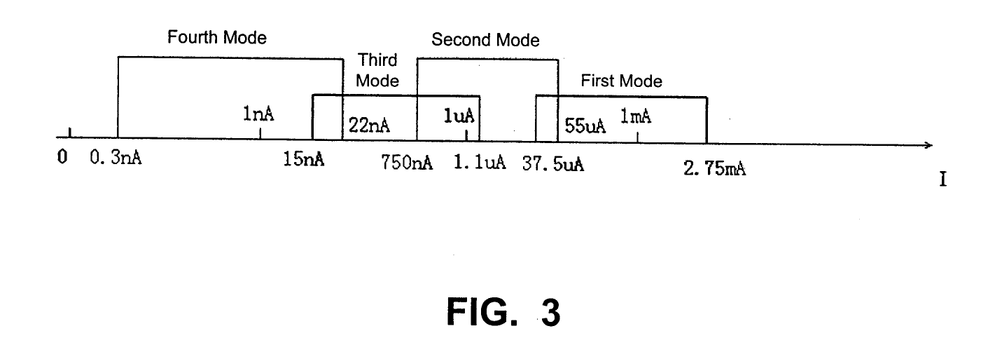

FIG. 2 is a circuitry of the amplifier circuit 104 in FIG. 1. Since four modes are provided in the embodiment 100, the amplifier circuit 104 includes four resistors 126, 128, 130 and 132 with resistances from low to high corresponding to each mode. The selection of resistances of four resistors 126˜132 depends on the optical power range of incident light beam and other associated factors. For example, if the maximum optical power range of the incident light beam is 3 dBm, the resistance of resistor 126 may be 400 Ω, and the resistances of resistor 128˜132 may be, respectively, 20 kΩ, 1 MΩ, and 50 MΩ. Referring to FIG. 3, the corresponding ranges of current are 37.5 μA˜2.75 mA, 750 nA˜55 μA, 15 nA˜1.1 μA, and 0.3 nA˜22 nA with respect to resistors 126, 128, 130, and 132. It should be noted that the value of resistance, e.g. 400 Ω for resistor 126, is a preferred value determined by experiments and not to limit the scope of the present invention. The resistance of resistor 126 may be other value, e.g. resistance larger than 100 Ω. Also, the range of current in each mode may depend on the relationship between the range of voltage, e.g. 15 mV˜1.1V, and the resistance of resistor in each mode when the optical power is in a specific range, e.g. +3 dBm˜−70 dBm. In this embodiment, for example, when the maximum optical power range of incident light beam is 3 dBm and four modes are implemented, resistance increment between modes is fifty-folds, which is a preferred empirical value. Thus, the resistance in the fourth mode is 50³=125000 times of the resistance in the first mode. In another embodiment, three modes are provided and each mode is X times of previous mode. The resistance in the third mode is X²=125000 times of the resistance in the first mode and thus X could be calculated as 353.6. Similarly, if N modes are provided, maximum range of incident light beam is 3 dBm, and the resistance in the first mode is 400 Ω in still another embodiment, the multiplier X between each mode could be obtain by a mathematical expression: X=125000^{[1/(N-1)]}. It should be noted that the value 125000 is a preferred maximum multiplier based on the minimum resistance of 400 Ω, and it varies correspondingly if the minimum value of resistance is rather than 400 Ω. The maximum multiplier is determined to allow at least voltage range of one mode being within the predetermined voltage range.

The relays are provided to switch between different resistors in accordance with the present invention. Since the on-resistance of the relay is very small, the linearity of the conversion from optical signal to electric signal is nearly unaffected. The number of relays depends on the required number of modes. The relay may include mechanical relay, solid relay, magnetic relay, etc, depending on the required level of linearity, size of volume, etc. In this embodiment 100, the amplifier circuit 104 utilizes three mechanical relay 134, 136, and 138 with resistances not larger than 10 Ω.

The amplifier 118 in the amplifier circuit 104 includes an inverting input terminal 120 and an output terminal 122. As shown in FIG. 2, the capacitor 124 has a first terminal 144 connected with the inverting input terminal 120 and a second terminal 146 connected with the output terminal 122. Each of resistors 126˜132, respectively, has a first end 148, 150, 152, and 154 connected to the inverting input terminal 120. Relay 134 has a first terminal 156 connected to the output terminal 122. Relay 134 is provided to select either relay 136 or relay 138. Relay 136 is provided to select either resistor 126 or resistor 128. Relay 138 is provided to select either resistor 130 or resistor 132.

In the embodiment 100, controller 106 may control relays 134˜138 via a control signal 116 to selectively connect one of the resistors 126˜132 to the output terminal 122. Switching between each mode is further described as follow. One of the resistors 126˜132 is connected to the output terminal 122 at beginning of the operation. For example, the first mode is set to be the default mode in the embodiment 100, i.e. the resistor 126 is connected to the output terminal 122. If the output voltage 142 from the output terminal 122 is not within a predetermined range, the controller 106 may switch relays 134˜138 to another mode until the output voltage 142 become within the predetermined range. The A/D converter 108 provides a better conversion within the predetermined range, i.e. linear conversion. For example, the predetermined range is between 15 mV˜1.1V. Note that whether the voltage 142 is within the predetermined range is determined by the controller 106 via the digital signal outputted from the A/D converter 108.

Referring to FIG. 1, when the voltage 142 is within the predetermined range, the controller 106 may display the corresponding result on the monitor 110 or transfer the result 117 to memory 114 for storing. Note that the result represents the optical power of incident light beam calculated from the digital signal. Besides, the embodiment 100 may further include an input device 112 for a user to communicate with the controller 106. The controller 106 may process the digital signal according to a wavelength of the incident light beam. For example, the user may input a specific wavelength of incident light beam to the controller 106, and then the controller 106 may process the digital signal according the characteristic of the photodiode 102 corresponding to this wavelength. Moreover, the controller 106 may process the digital signal according to a display format of the result. For example, the user may input desired displayed power unit to the controller 106, and the controller 106 may calculate the result based on the selected power unit.

The above description only sets forth preferred embodiment of the invention, and is not intended to limit the scope, applicability, or configuration of the invention in any way. Rather, various changes may be made in the function and arrangement of the elements described in the embodiment without departing from the spirit and scope of the invention. Thus, the protected scope of the present invention is as set forth in the appended claims.

1. An optical power meter, comprising:
a photodiode for generating a current based on power of an incident light beam; and
an amplifier circuit for converting the current into a voltage, the amplifier circuit comprising:
an amplifier having an inverting input terminal and an output terminal;
a plurality of resistors, each of the resistors having a first terminal connected with the inverting input terminal; and
a relay having a first terminal connected with the output terminal;
wherein the relay selectively connects one of the plurality of resistors with the output terminal so that the value of the voltage outputted by the output terminal is within a predetermined range, and the on-resistance of the relay is not larger than 10 ohms.

2. The optical power meter of claim 1, wherein the predetermined range is from 15 mV to 1.1 V.

3. The optical power meter of claim 1, further comprising:
a controller having an analog-to-digital (A/D) converter for converting the voltage into a digital signal, wherein the controller utilizes the digital signal to determine whether the value of the voltage is within the predetermined range.

4. The optical power meter of claim 3, wherein the controller further controls the relay to selectively connect one of the plurality of resistors with the output terminal.

5. The optical power meter of claim 4, wherein the photodiode is an InGaAs positive-intrinsic-negative photodiode.

6. The optical power meter of claim 4, wherein the A/D converter is a 24 bits A/D converter.

7. The optical power meter of claim 1, wherein a minimum value of the resistances of the plurality of resistors is not less than 100 ohm.

8. The optical power meter of claim 4, wherein the relay is a mechanical relay.

9. The optical power meter of claim 4, wherein the controller further processes the digital signal according to a wavelength of the incident light beam.

10. The optical power meter of claim 4, wherein the controller processes the digital signal to generate a result, and the controller processes the digital signal according to a display format of the result.

11. The optical power meter of claim 1, wherein the amplifier further comprises a capacitor having a first terminal connected with the inverting input terminal and a second terminal connected with the output terminal.

12. The optical power meter of claim 11, further comprising:
a monitor for displaying a result; and
an input device for a user to communicate with the controller.

13. An optical power meter, comprising:
a photodiode for generating a current based on power of an incident light beam;
an amplifier circuit for converting the current into a voltage, the amplifier circuit comprising:
an amplifier having an inverting input terminal and an output terminal;
a capacitor having a first terminal connected with the inverting input terminal and a second terminal connected with the output terminal;
a plurality of resistors, each of the resistors having a first terminal connected with the inverting input terminal; and
a relay having a first terminal connected with the output terminal, wherein the relay selectively connects one of the plurality of resistors with the output terminal so that the value of the voltage outputted by the output terminal is within a predetermined range, and the on-resistance of the relay is not larger than 10 ohms; and
a controller having an analog-to-digital (A/D) converter for converting the voltage into a digital signal, wherein the controller utilizes the digital signal to determine whether the value of the voltage is within the predetermined range and controls the relay to selectively connect one of the plurality of resistors with the output terminal.

14. The optical power meter of claim 13, wherein the predetermined range is from 15 mV to 1.1 V.

15. The optical power meter of claim 13, wherein the photodiode is an InGaAs positive-intrinsic-negative photodiode.

16. The optical power meter of claim 13, wherein the A/D converter is a 24 bits A/D converter.

17. The optical power meter of claim 13, wherein a minimum value of the resistances of the plurality of resistors is not less than 100 ohm.

18. The optical power meter of claim 13, wherein the relay is a mechanical relay.

19. The optical power meter of claim 13, wherein the controller further processes the digital signal according to a wavelength of the incident light beam.

20. The optical power meter of claim 13, wherein the controller processes the digital signal to generate a result, and the controller processes the digital signal according to a display format of the result.
